(19) United States
(12) Patent Application Publication
(10) Pub. No.: US 2014/0068657 A1
(43) Pub. Date: Mar. 6, 2014

(54) METHOD AND APPARATUS FOR INSERTING ADVERTISING INTO A VIDEO SIGNAL AT A RECEIVING DEVICE NOT HAVING A DIGITAL VIDEO RECORDER (NON-DVR) RECEIVER

(71) Applicant: Tam T. Leminh, Cypress, CA (US)

(72) Inventor: Tam T. Leminh, Cypress, CA (US)

(73) Assignee: The DIRECTV Group, Inc., El Segundo, CA (US)

(21) Appl. No.: 13/598,395

(22) Filed: Aug. 29, 2012

(51) Int. Cl. H04N 21/23

(52) U.S. Cl. 725/32

(57) ABSTRACT

A system and method of operating a non-recordable receiving device comprises a video storage device and a network. The non-DVR receiving device is separate from the video storage device and communicates with the video storage device through the network. The non-DVR receiving device receives a video signal, monitors the television signal for an insert indicator and proximate the insert indicator, communicates an advertisement request signal from the non-DVR receiving device to the video storage device through the network. The video storage device communicates an advertisement to the non-DVR receiving device in response to the advertisement request signal. The non-DVR receiving device displays the advertisement on a display associated with the non-DVR receiving device.

### TECHNICAL FIELD

The present disclosure relates generally to inserting advertising into a video signal and, more specifically to inserting advertising into a video signal at a non-DVR receiving device.

### BACKGROUND

The statements in this section merely provide background information related to the present disclosure and may not constitute prior art.

Advertising in the television medium is commonly done on a national level. Advertising is broadcast nationwide for most time slots with a television signal. Advertising may be inserted at the content source such as the television network. Some advertisements are inserted at a head end. Local television stations are allotted some time slots for inserting advertising that is directed to a local viewing market. Stores and various other types of local commercial ventures purchase air time from broadcasters for the placement of advertising. Advertising is typically broadcast as part of the signal and is transmitted to all the viewers in the local market. Thus, the advertising is generated to a wide audience and is priced accordingly. Some businesses are local even within a particular market. Advertising over the entire market may be cost prohibitive. Advertisers would like the option to advertise very locally within a local market.

Local advertising is one way to provide specific information to specific viewers. Another way to provide advertising is based upon a profile. A profile may consist of user-entered likes and dislikes as well as other factors such as geographic location, and the like. Advertisements may be selected for specific user attributes and typically are stored within a set top box DVR. However, many service providers have set top boxes without digital video recorders (non-DVR receiving devices). Therefore, there has been no way to provide targeted advertisements to users of such devices.

### SUMMARY

The present disclosure is directed to inserting advertising into a video signal using a non-digital video recorder receiving device.

In one aspect of the disclosure, a method operating a non-digital video recorder (DVR) receiving device includes communicating a television signal to a non-DVR receiving device, monitoring the video signal for an insert indicator, proximate the insert indicator, communicating an advertisement request signal from the non-DVR receiving device to a video storage device through a network, in response to the advertisement request signal, communicating an advertisement to the non-DVR receiving device and displaying the advertisement on a display associated with the non-DVR receiving device.

In a further aspect of the disclosure, a system and method of operating a non-digital video recorder receiving device comprises a video storage device and a network. The non-DVR receiving device is separate from the video storage device and communicates with the video storage device through the network or internet. The non-DVR receiving device receives a television signal, monitors the video signal for an insert indicator and proximate the insert indicator, communicates an advertisement request signal from the non-DVR receiving device to the video storage device through the network or internet. The video storage device communicates an advertisement to the non-DVR receiving device in response to the advertisement request signal. The non-DVR receiving device displays the advertisement on a display associated with the non-DVR receiving device.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagrammatic view of a satellite broadcasting system according to the present disclosure.

FIG. 2 is a block diagrammatic view of a non-digital video recorder receiving device.

FIG. 3 is a block diagrammatic view of a receiving device with a digital video recorder.

FIG. 4 is a representation of a video signal according to the present disclosure.

FIG. 5 is a flowchart of a method of storing advertising in a video storage device.

FIG. 6 is a flowchart of a method of displaying an advertisement on a display associated with a non-DVR receiving device.

### DETAILED DESCRIPTION

The following description is merely exemplary in nature and is not intended to limit the present disclosure, application, or uses. For purposes of clarity, the same reference numbers will be used in the drawings to identify similar elements. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical OR. It should be understood that steps within a method may be executed in different order without altering the principles of the present disclosure.

The teachings of the present disclosure can be implemented in a system for communicating content to an end user or user device. Both the data source and the user device may be formed using a general computing device having a memory or other data storage for incoming and outgoing data. The memory may comprise but is not limited to a hard drive, FLASH, RAM, PROM, EEPROM, ROM phase-change memory or other discrete memory components.

Each general purpose computing device may be implemented in analog circuitry, digital circuitry or combinations thereof. Further, the computing device may include a microprocessor or microcontroller that performs instructions to carry out the steps performed by the various system components.

A content or service provider is also described. A content or service provider is a provider of data to the end user. The service provider, for example, may provide data corresponding to the content such as metadata as well as the actual content in a data stream or signal. The content or service provider may include a general purpose computing device, communication components, network interfaces and other associated circuitry to allow communication with various other devices in the system.

Further, while the following disclosure is made with respect to the delivery of video (e.g., television (TV), movies, music videos, etc.), it should be understood that the systems and methods disclosed herein could also be used for delivery of any media content type, for example, audio, music, data files, web pages, advertising, etc. Additionally, throughout this disclosure reference is made to data, content, information, programs, movie trailers, movies, advertising, assets, video data, etc., however, it will be readily apparent to persons of ordinary skill in the art that these terms are substantially equivalent in reference to the example systems and/or methods disclosed herein. As used herein, the term title will be used to refer to, for example, a movie itself and not the name of the movie. Insert detailed description.

While the following disclosure is made with respect to example DIRECTV® broadcast services and systems, it should be understood that many other delivery systems are readily applicable to disclosed systems and methods. Such systems include wireless terrestrial distribution systems, wired or cable distribution systems, cable television distribution systems, Ultra High Frequency (UHF)/Very High Frequency (VHF) radio frequency systems or other terrestrial broadcast systems (e.g., Multi-channel Multi-point Distribution System (MMDS), Local Multi-point Distribution System (LMDS), etc.), Internet-based distribution systems, cellular distribution systems, power-line broadcast systems, any point-to-point and/or multicast Internet Protocol (IP) delivery network, and fiber optic networks. Further, the different functions collectively allocated among a service provider and integrated receiver/decoders (IRDs) as described below can be reallocated as desired without departing from the intended scope of the present patent.

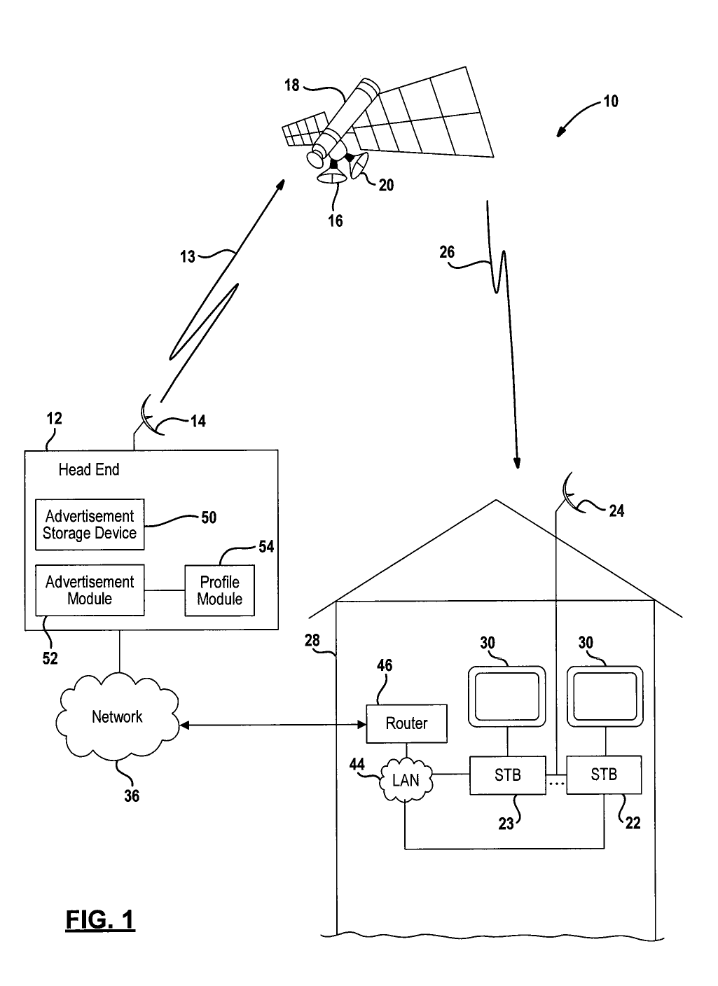

Referring now to FIG. 1, a satellite television broadcasting system 10 is illustrated. The satellite television broadcast system 10 includes a head end 12 that generates wireless signals 13 through an antenna 14 which are received by an antenna 16 of a satellite 18. The wireless signals 13, for example, may be digital. The wireless signals 13 may be referred to as an uplink signal. A transmitting antenna 20 generates downlink signals that are directed to various receiving systems including stationary systems such as those in the home, as well as, mobile receiving systems. Television receiving devices 22, 23 are examples of a stationary receiving system. The receiving devices 22, 23 may be referred to as set top boxes or satellite television receiving devices. As mentioned above, a terrestrial distribution system may replace the satellite.

The television receiving devices 22, 23 may be part of a network 44. The television receiving device 22 may be a non-digital video recorder receiving device (non-DVR receiving device). That is, the non-DVR receiving device 22 may not include a digital video recorder therein. Receiving devices without DVRs are commonly used to reduce costs in secondary locations within a home. The receiving device 23 may be a DVR receiving device. That is, the receiving device 23 may include a digital video recorder. A digital video recorder is used to record or store various television content. In addition, the digital video recorder may be used to store advertisements. In general, advertisements may be stored then played back through the digital video recorder receiving device and through the non-digital video recorder receiving device 22 when the advertisements are communicated to the non-digital video receiving device 22 from the digital video recorder receiving device 23 through the network 44.

The receiving devices 22, 23 are in communication with an antenna 24. The antenna 24 receives downlink signals 26 from the transmitting antenna 20 of the satellite 18.

The present example is set forth by way of a building 28 such as a home. The building 28 may include a plurality of rooms each of which has a receiving device 22, 23. The receiving devices 22, 23 are associated with a single user account. The building 28 may be a home or commercial building.

The head end 12 may communicate various content, advertisements program guide data or other data through the satellite 18. The receiving devices 22, 23 may receive the content, advertisements and data.

The receiving devices 22, 23 each have a display 30 associated therewith. The display 30 may be a television or monitor used for displaying video images and providing an audio output.

A network 36 may be used to connect the head end 12 with various devices included the receiving devices 22, 23. The network 36 may be one type of network or multiple types of networks. The network 36 may, for example, be a public switched telephone network, the internet, a mobile telephone network, another type of network, or combinations thereof. The network 36 may also be a cloud network. The network 36 may be used for streaming content or advertisements to the user devices. The network 36 may communicate the content or ads in an IP format.

The local area network (LAN) 44 may also be incorporated into the building 28. The local area network 44 may be in communication with the receiving devices 22, 23. The local area network 44 may be a wireless local area network or a wired network.

The local area network 44 may include a router 46. The router 46 may allow the devices within the local area network 44 to communicate. In this example, the local area network 44 may allow the non-DVR receiving device 22 to communicate with the receiving device 23 having a DVR and vice versa. The router 46 may also allow devices within the network 44 to communicate with the network 36. For example, the DVR receiving device 23 and non-receiving device 22 can communicate with the head end 12 and the modules therein.

In the present disclosure, two examples of providing advertisements are set forth. Advertisements may be communicated to and stored in the DVR receiving device 23 and then communicated to the non-DVR receiving device 22. Alternatively, the non-DVR receiving device may also receive advertisements directly from the head end 12.

The head end 12 includes an advertisement storage device 50 used for storing advertisements therein. The advertisement storage device 50 may store different advertisements to be used for different groups or types of receiving devices. User characteristics may be stored with the ads so that when a user profile is compared thereto, suitable advertisements are provided to the users.

The head end may also include an advertisement engine module (ad engine) 52. The ad engine 52 may receive an advertisement request through the network 36 that originates from the non-DVR receiving device 22. The ad engine 52 receives the request and communicates advertisements to the non-DVR receiving device. The ad engine 52 may communicate specific ads based upon the profile within the profile module 54. That is, the request for an advertisement may include a receiving device identifier that corresponds to a profile stored within the profile module 54. Based upon the user profile stored within the profile module 54 and the user characteristics of an advertisement, a targeted ad may be communicated to a particular receiving device.

The ad engine 52 may also communicate ads to the DVR receiving device 23. The DVR within the DVR receiving device 23 may store the advertisements and communicate the advertisements to the non-DVR receiving device 22 upon request. Further, ads may also be stored in the head end or cloud and may be communicated to the non-DVR receiving device 22.

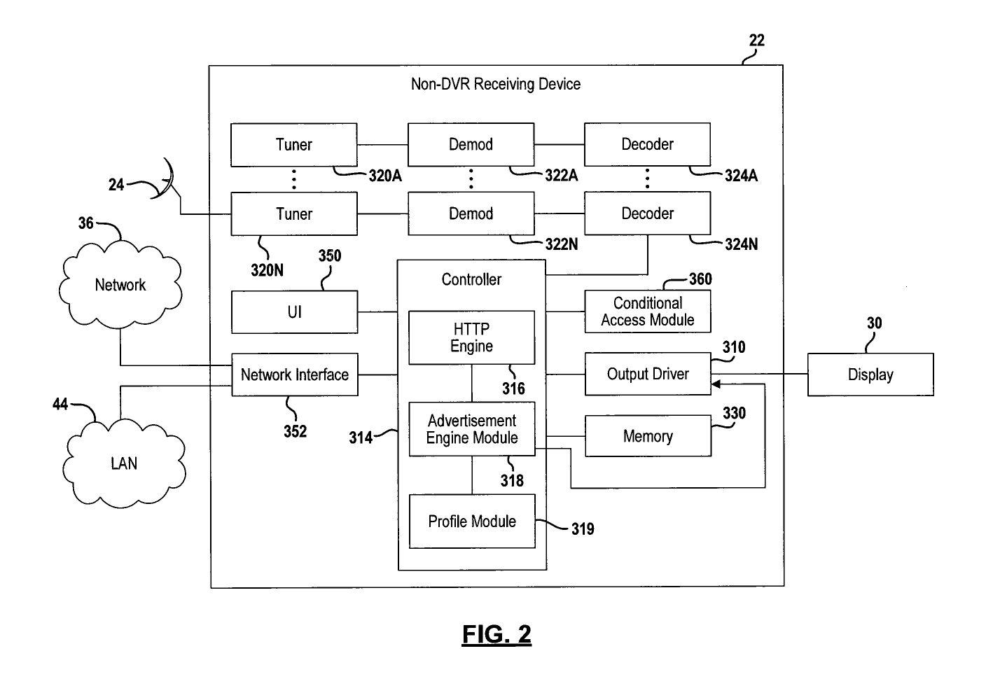

Referring now to FIG. 2, the non-DVR receiving device 22 or set top box is illustrated in further detail. Although, a particular example using the set top box is illustrated, it is merely representative of various electronic devices with an internal controller used as a content receiving device. The antenna 24 may be one of a number of different types of antennas that may include one or more low noise blocks associated therewith. The antenna 24 may be a single antenna used for satellite television reception. Of course, multiple antennas for receiving signals from satellites in different orbital slots may be used. In a terrestrial system such as a cable television system, no antenna may be used. Rather, a connector to a fiber optic or coaxial cable may be used. The non-DVR receiving device 22, as described above, is coupled to a display 30. The display 30 may have an output driver 310 within the non-DVR receiving device 22.

A controller 314 may be a general processor such as a microprocessor that cooperates with control software. The controller 314 may be used to coordinate and control the various functions of the non-DVR receiving device 22. These functions may include tuner 320A-320N (collectively 320), demodulator 322A-322N (collectively 322), decoders 324A-324N (collectively 324) such as forward error correction decoders and any buffer or other functions.

The tuners 320 receive the signal or data from the individual channel. The tuners 320 may receive data from a satellite or a terrestrial source such as a cable. The tuners 320 may receive television programming content, program guide data or other types of data. The demodulators 322 demodulate the signal or data to form a demodulated signal or data. The decoders 324 decode the demodulated signal to form decoded data or a decoded signal. The controller 314 may be similar to that found in current DIRECTV® set top boxes which uses a chip-based multifunctional controller. By providing a number of tuners, demodulators and decoders, a number of different content programs may be used by the receiving device. For example, live viewing and recording may be performed simultaneously. A number of recordings may be made simultaneously depending on the number of tuners available.

The controller 314 may also include a hypertext transfer protocol (HTTP) engine module 316. The HTTP engine module 316 (HTTP engine) is used to receive commands from the local area network 44 and communicate formatted commands to the local area network 44. The HTTP engine module 316 receives the commands that are acted upon by the controller 314. The HTTP signals communicated by the HTTP engine 316 may include a request for an advertisement or advertisements. The HTTP signals may also include the advertisements themselves or links to advertisements.

The controller 314 may also include an advertisement engine 318. The advertisement engine 318 may be used to monitor the broadcast signal being displayed at the display 30. The advertisement engine 318 may look for a signal cue to determine that an advertising may need to be placed within the signal. The advertisement engine 318, as will be described below, may use a break descriptor as a cue for determining that an upcoming timeframe requires an advertisement. A break descriptor may be provided before a trigger for inserting the advertisement. The advertisement engine 318 may also be in communication with a profile module 319. A break descriptor may contain metadata for profile module 319 to select particular ads at this time. The profile module 319 includes a profile of the user. The profile is used to compare with user characteristics of an advertisement so that content or advertisements suitable for a particular user are provided. The profile module 319 may include profile characteristics such as user location, user likes and dislikes that have been expressly entered into the system, programming previously watched, and the program being watched currently. Algorithms may be used to generate profile characteristics based on weights. The advertisement engine 318 may refer to the profile module 319 and request or retrieve advertisements. That is, in one example, advertisements may be retrieved from the digital video recorder set forth in a DVR receiving device. The advertisements may also be requested from the head end and the advertisement storage device 50 as illustrated in FIG. 1.

The profile module 319 may also be used to build a profile which may be stored within the memory 330. The profile module 319 may monitor the programming watched and add it to the profile. From the profile, advertisements likely to be relevant to a user may be obtained.

The controller 314 is in communication with a memory 330. The memory 330 is illustrated as a single box. The memory 330 may actually be a plurality of different types of memory including the hard drive, a flash drive and various other types of memory. The memory 330 may be other types of memory or sections of different types of memory. The memory 330 may be non-volatile memory or volatile memory.

The memory 330 may include storage for various operational data collected during operation of the non-DVR receiving device 22. For example, the memory 330 may store a profile or the data used to build the profile. Another type of data stored in the memory is the favorite settings for the non-DVR receiving device 22. Another type of data in the memory 330 may include the channels subscription data, the blocked channels, adult channels, rating limits set by the non-DVR receiving device 22, current set top box language, TV resolution data, to do list data, the conditional access module identifier, time zone data, time of day daylight savings, status data, aspect ratio data, viewing hours data, quick tune list and a zip code.

The memory 330 may also store the advanced program guide data. The memory 330 may store program guide data that is received at the head end. The program guide data may include amounts of data including two or more weeks' worth of program guide data. The program guide data may be communicated to the non-DVR receiving device 22 in various manners including through the satellite 18 of FIG. 1. The program guide data may include a content or program identifiers, and various data objects corresponding thereto. The content identifier may include series data. The first 4 digits may, for example, identify the series. The program guide may include program characteristics for each program content. The program characteristic may include ratings, categories, actor, director, writer, content identifier, producer data and event type. The data may also include various other settings.

The non-DVR receiving device 22 may also include a user interface 350. The user interface 350 may be various types of user interfaces such as a keyboard, push buttons, a touch screen, a voice activated interface or the like. The user interface 350 may be used to select a channel, select various information, change the volume, change the display appearance, or other functions. The user interface 350 may also be used for selecting recommendation and providing feedback for recommendations as will be described below.

A network interface 352 may be included within the non-DVR receiving device 22 to communicate various data through the networks 36/44 described above. The network interface 352 may be a WiFi, WiMax, WiMax mobile, wireless, cellular, or other types of communication systems. The network interface 352 may use various protocols for communication therethrough including, but not limited to, hypertext transfer protocol (HTTP).

The non-DVR receiving device 22 may also include a conditional access module 360. The conditional access module 360 prevents unauthorized reception of the television signals through the antenna 24. The conditional access module 360 may use a cryptographic hash to authorize the use and display of the received signals.

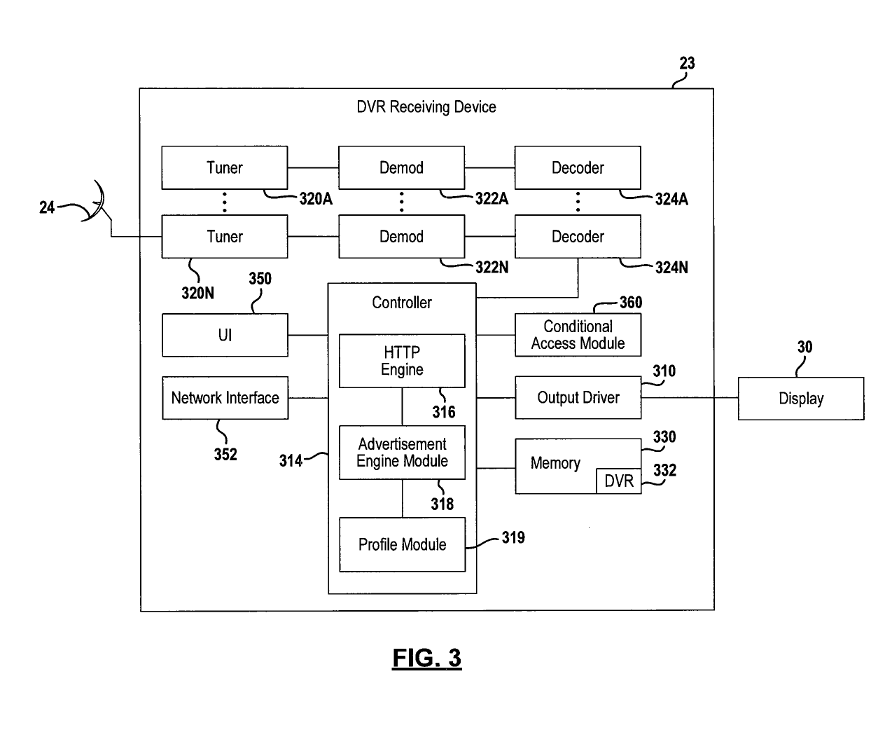

Referring now to FIG. 3, a DVR receiving device 23 is illustrated in further detail. The DVR receiving device 23 may include similar components to those described above relative to the non-DVR receiving device 22 set forth in FIG. 2. In this example, the memory 330 may include a DVR 332. The DVR may include recorded content as well as advertisements to be communicated to the non-DVR receiving device 22. The HTTP engine 316 may receive requests for advertising from the non-DVR receiving device 22 and may retrieve the advertisements from the DVR 332. The advertisement engine module 318 may be used to retrieve the advertisements from the DVR. The advertisement engine module 318 may use the profile module 319 to determine advertisements that are suitable for the user. That is, based upon a comparison of the user profile and user characteristics of the advertisement, suitable advertisements for the user may be determined.

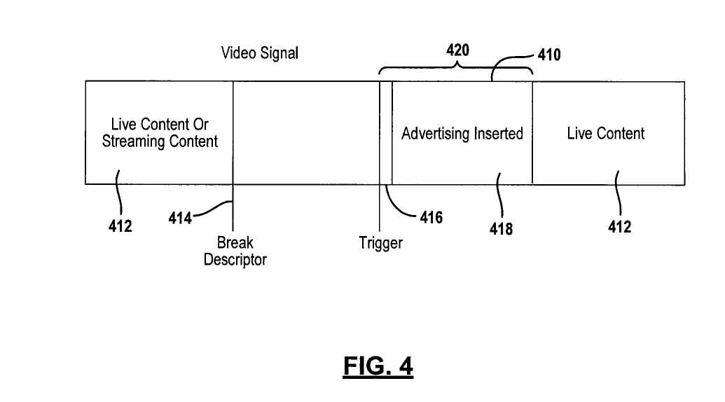

Referring now to FIG. 4, a video signal 410 is illustrated. The video signal 410 includes live television content or live streaming content 412. The live content 412 may include an insert indicator for indicating an upcoming advertising break. The insert indicator may be one tone or signal. In the present example the insert indicator includes a break descriptor 414 and a trigger 416. The break descriptor 414 may be a tone or another type of digital signal included directly in or broadcasted together with the television signal 410. The break descriptor may not be perceivable by the user. The break descriptor 414 comes a pre-determined time before the trigger 416. The break descriptor 414 may also include various data including the amount of time that will be allotted for insert advertising and/or the number of ads. For example, 30 seconds, 60 seconds, 90 seconds may be set as a time window. The break descriptor 414 may trigger the advertisement engine module to retrieve advertising for insertion within the television signal 410. The advertisement may replace or be substituted for the broadcasted advertisement. At the trigger 416, the advertising is inserted into the live content signal. Alternatively, the trigger 416 may also indicate the exact timeframe to insert the ads into the live content. Advertising 418 is inserted after the trigger 416. After the advertising timeslot, regular live content 412 is resumed. As mentioned above, the advertising 418 may be one or more advertising segments whose total fill the timeslot for advertising 420.

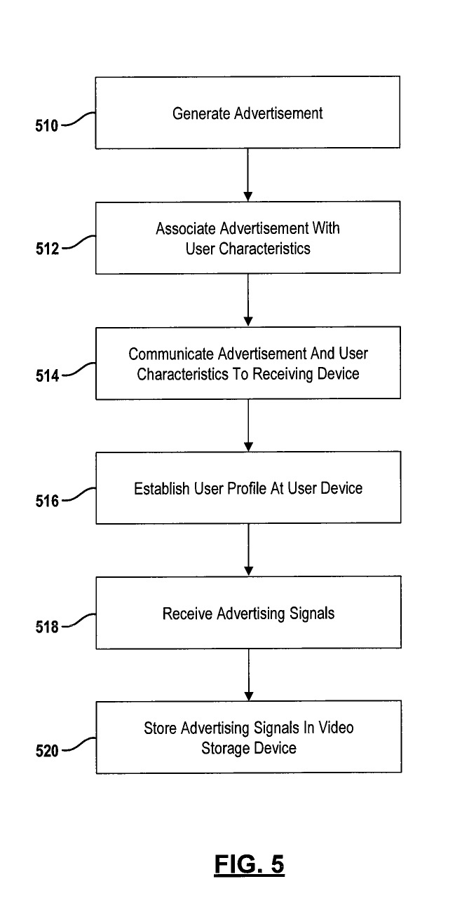

Referring now to FIG. 5, a method for storing advertising signals in a storage device is set forth. In step 510, advertisements are generated or received. As mentioned above, the advertisements may be received at the head end in FIG. 1. In step 512, the advertisement is associated with user characteristics. That is, various types of data may be associated with an advertisement including geographic locations and user characteristics. For example, a user characteristic may correspond to sporting events. Users that watch a significant amount of sporting events may find the advertisement suitable. Another example is that people who watch cooking shows may find advertisements for pots and pans suitable.

In step 514, the advertisement and user characteristics are communicated to a storage device which may be in a DVR receiving device or a storage device at the head end. In step 516, a user profile is established at one or more of the receiving devices associated with the account. The user profile may be established over time and in response to programming content viewed or stored within a digital video recorder or watched through a tuner. Over time, the user profile may continually evolve or by sending data about user to evolve profile data like income, online purchase, auto and model year etc. In step 518, advertising signals having an advertisement therein are received at the DVR receiving device. In step 520, the advertising signals are stored in the video storage device. As mentioned above, the advertising signals having advertisements therein may be stored within a digital video recorder in a digital video recorder receiving device. Only ads relevant to user are stored.

Steps 518 and 520 are used when the advertisements are stored within the network. In the alternative, the advertisement may be maintained at the head end and stored in the storage device 52 of the head end 12 illustrated in FIG. 1 rather than communicating the advertisement to a digital video recorder receiving device.

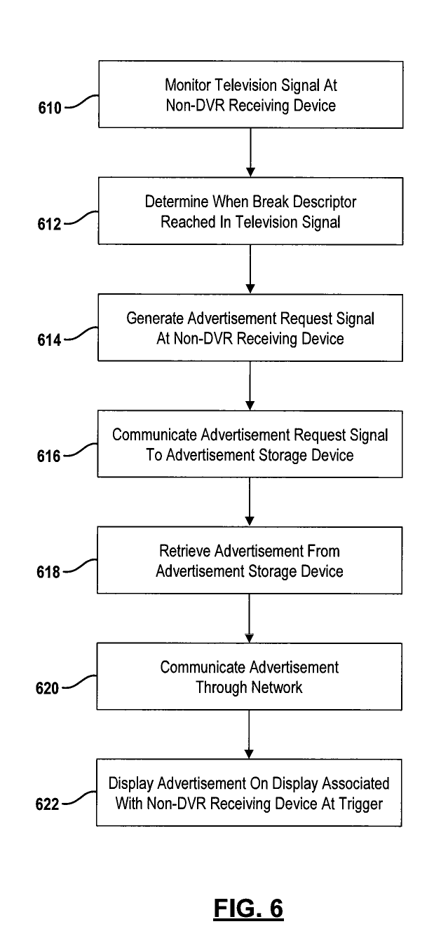

Referring now to FIG. 6, a method for displaying the advertisement is set forth. In step 610, a television signal is received at a non-digital video recorder (non-DVR) receiving device. In step 612, a break descriptor is reached within the television signal being played out. As mentioned above, the break descriptor may be a digital signal that not only describes that an upcoming break is eminent but that the time of the break is a predetermined time window. In step 614, an advertisement request signal is generated by the advertisement engine within the non-DVR receiving device. The request may identify the type of ads at this time or specific ads at this time lot. In step 616, the advertisement request signal is communicated to the advertisement storage device through the network. As mentioned above, the advertisement storage device may be a DVR receiving device, or retrieve from head end or the storage device at the head end. In step 618, the advertisement is retrieved from the advertisement storage device or head end. The advertisement request signal may include an identifier that corresponds with the user account or the non-DVR receiving device. Step 618 may perform the retrieval of the advertisement based upon a profile. The profile may be associated with the user identifier at the advertisement storage device. In step 620, the advertisement is communicated through the network to the non-DVR receiving device. In step 622, the advertisement is displayed on a display associated with the non-DVR receiving device at the trigger. Thus, the advertisement replaces the advertisement broadcasted within the live signal.

As mentioned above, the advertisement may be communicated through the network such as the internet from either the DVR storage device or an advertisement storage device located within the head end remotely. A profile may or may not be used to select appropriate advertisements for the user account.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

1. A method operating a non-digital-video-recorder (non-DVR) receiving device comprising:
communicating a television signal comprising a break descriptor prior in time to a trigger to a non-DVR receiving device;
monitoring the television signal for the break descriptor;
in response to the break descriptor, communicating an advertisement request signal from the non-DVR receiving device to a video storage device through a network;
in response to the advertisement request signal, communicating an advertisement to the non-DVR receiving device; and
displaying the advertisement on a display associated with the non-DVR receiving device at the trigger.

2. The method as recited in claim 1 wherein communicating the television signal to the non-DVR receiving device comprises communicating the television signal to a non-DVR satellite receiving device through a satellite.

3. The method as recited in claim 1 wherein communicating the television signal to the non-DVR receiving device comprises communicating the television signal to the non-DVR receiving device through a terrestrial system.

4. The method as recited in claim 1 wherein communicating the television signal to the non-DVR receiving device comprises communicating the television signal to the non-DVR receiving device through a live streaming or Internet Protocol network.

5. The method as recited in claim 1 wherein communicating the advertisement request signal from the non-DVR receiving device to the video storage device through the network comprises communicating the advertisement request signal from the non-DVR receiving device to a receiving device having a digital video recorder.

6. The method as recited in claim 1 wherein communicating the advertisement request signal from the non-DVR receiving device to the video storage device through the network comprises communicating the advertisement request signal from the non-DVR receiving device to a satellite receiving device having a digital video recorder.

7. The method as recited in claim 1 wherein communicating the advertisement request signal from the non-DVR receiving device to the video storage device through the network comprises communicating the advertisement request signal from the non-DVR receiving device to a receiving device having a digital video recorder through a local area network.

8. The method as recited in claim 7 wherein communicating the advertisement to the non-DVR receiving device comprises communicating the advertisement to the non-DVR receiving device through the local area network.

9. The method as recited in claim 1 wherein communicating the advertisement request signal from the non-DVR receiving device to the video storage device through the network comprises communicating the advertisement request signal from the non-DVR receiving device to a remotely located advertisement storage device through an internet.

10. The method as recited in claim 9 wherein communicating the advertisement to the non-DVR receiving device comprises communicating the advertisement to the non-DVR receiving device through the internet.

11. The method as recited in claim 1 further comprising retrieving the advertisement from the video storage device based on a user profile.

12. The method as recited in claim 11 further comprising associating user characteristics with the advertisement and wherein retrieving is performed in response to comparing the user characteristics and the profile.

13. (canceled)

14. A system comprising:
a video storage device;
a network;
a non-DVR receiving device separate from the video storage device and communicating with the video storage device through the network, said non-DVR receiving device receiving a video signal comprising a break descriptor prior in time to a trigger, monitoring the video signal for the break descriptor and, in response to the break descriptor, communicating an advertisement request signal from the non-DVR receiving device to the video storage device through the network;
said video storage device communicating an advertisement to the non-DVR receiving device in response to the advertisement request signal; and
said non-DVR receiving device displaying the advertisement on a display associated with the non-DVR receiving device at the trigger.

15. The system as recited in claim 14 further comprising a satellite communicating the video signal to the non-DVR receiving device.

16. The system as recited in claim 14 further comprising a terrestrial system communicating the video signal to the non-DVR receiving device.

17. The system as recited in claim 14 wherein the terrestrial system streams the video signal to the non-DVR receiving device.

18. The system as recited in claim 14 wherein the terrestrial system streams the video signal to the non-DVR receiving device through the internet.

19. The system as recited in claim 14 further comprising a digital video recorder receiving device comprising the video storage device.

20. The system as recited in claim 14 further comprising a satellite television digital video recorder receiving device comprising the video storage device.

21. The system as recited in claim 14 wherein the network comprises a local area network.

22. The system as recited in claim 21 wherein the storage device communicates the advertisement to the non-DVR receiving device through the local area network.

23. The system as recited in claim 14 wherein an internet is disposed between the video storage device and the non-DVR receiving device.

24. The system as recited in claim 23 wherein the video storage device communicates the advertisement to the non-DVR receiving device through the internet.

25. The system as recited in claim 14 wherein the video storage device retrieves the advertisement from the video storage device based on a user profile.

26. The system as recited in claim 25 further comprising associating user characteristics with the advertisement and wherein retrieving is performed in response to comparing the user characteristics and the profile.

27. (canceled)
